(19) United States
(12) Patent Application Publication
(10) Pub. No.: US 2017/0032341 A1
(43) Pub. Date: Feb. 2, 2017

(54) Traceable Deposit Container

(71) Applicant: Bank of America Corporation, Charlotte, NC (US)

(72) Inventor: Darrell Johnsrud, Washougal, WA (US)

(21) Appl. No.: 14/814,944

(22) Filed: Jul. 31, 2015

(51) Int. Cl. G06Q 20/10; G06Q 20/40; B65D 55/06; G06Q 10/08

(52) U.S. Cl. CPC G06Q 20/108; G06Q 10/0833; G06Q 20/4014; B65D 55/06

(57) ABSTRACT

Systems, methods, apparatuses, and computer-readable media for transferring funds from a first entity, such as a business, to a second entity, such as a financial institution are provided. The funds may be counted and loaded into a deposit container that may be tracked. An amount of funds loaded into the container may be transmitted to the second entity as an expected amount of funds being transferred. The deposit container may then be transferred to the second entity where the funds may be removed from the deposit container. The funds may be counted by the second entity and an amount of funds removed from the deposit container may be determined. A comparison may be made between the expected amount of funds and the received amount of funds and, if the amounts match, the deposit transaction may be completed. If the funds do not match, the deposit transaction may include further processing.

### BACKGROUND

Businesses, such as retail stores, restaurants, and the like, often collect various amounts of cash (e.g., paper currency and coins) throughout the day. In addition, checks or other negotiable instruments, foreign currency, and the like, may also be collected by businesses. These businesses must then transfer the collected funds from the location of the business to a bank or other financial institution for deposit. In conventional systems, a manager or senior employee of the business may collect the funds in a bag and transport the funds to the financial institution. In some larger businesses, an armored car service may collect the funds and transport them. However, these arrangements may be time consuming, inefficient and prone to errors, theft, and the like. Further, these arrangements may have very little capability to track the funds (or the bag containing the funds) while the funds are being transported.

### SUMMARY

Aspects of the disclosure relate to various systems, methods, apparatuses, and computer-readable media for transferring funds from a first entity, such as a business, to a second entity, such as a financial institution. In some examples, the funds may be counted and loaded into a deposit container that may be tracked. An amount of funds loaded into the container may be transmitted to the second entity as an expected amount of funds being transferred. The deposit container may then be transferred, by a courier or agent authenticated by the system, to the second entity, where the funds may be removed from the deposit container.

Upon arrival at the second entity, or removal from the deposit container, the funds may be counted and an amount of funds removed from the deposit container may be determined. A comparison may be made between the expected amount of funds and the received amount of funds and, if the amounts match, the deposit transaction may be completed. If the funds do not match, the deposit transaction may include further processing to place a hold on the funds being deposited.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects discussed herein;

FIG. 2 depicts an illustrative block diagram of workstations and servers that may be used to implement the processes and functions of certain aspects of the present disclosure in accordance with one or more aspects discussed herein;

FIG. 3 illustrates one example traceable container transfer system in accordance with one or more aspects discussed herein;

FIG. 4 illustrates another example deposit container filling system in accordance with one or more aspects described herein;

FIGS. 5A and 5B illustrate one example event sequence for counting funds, placing the funds in a deposit container and transferring the deposit container from a first entity to a second entity in accordance with one or more aspects described herein;

FIG. 6 illustrates one example method of loading funds in a deposit container and transferring the container from a first entity to a second entity in accordance with one or more aspects described herein;

FIG. 7 illustrates one example method of authenticating a user request to remove and transfer the deposit container in accordance with one or more aspects described herein; and

FIGS. 8-10 illustrate various user interfaces for authenticating a user requesting to transfer a deposit container in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of this disclosure relate to systems and methods for transferring funds in a deposit container from a first entity, such as a retail location, to a second entity, such as a financial institution. In some examples, one or more aspects of the systems and methods described herein may be performed automatically or via an automated process. In some examples, the funds for transfer (e.g., funds collected at the first entity to be deposited at the second entity) may be contained within a reusable, traceable container that is physically transported from the location of the first entity to the location of the second entity (the first and second entities may be different entities and/or may be located in different locations). The container may include a tamper resistant seal. Accordingly, a courier (e.g., an authorized agent) may collect the container from the first entity and deliver it to the second entity for processing, deposit, and the like. In some examples, the courier may be, for instance, an armored car service. In other examples, the courier may be a for-hire ride sharing service or other type of delivery service. For instance, various grocery stores or grocery services provide delivery options. That delivery service may be available to collect a deposit container and transport it to the financial institution. In another example, known package delivery companies may also be used to collect a deposit container and transport it to the second entity. These and other features will be described more fully below.

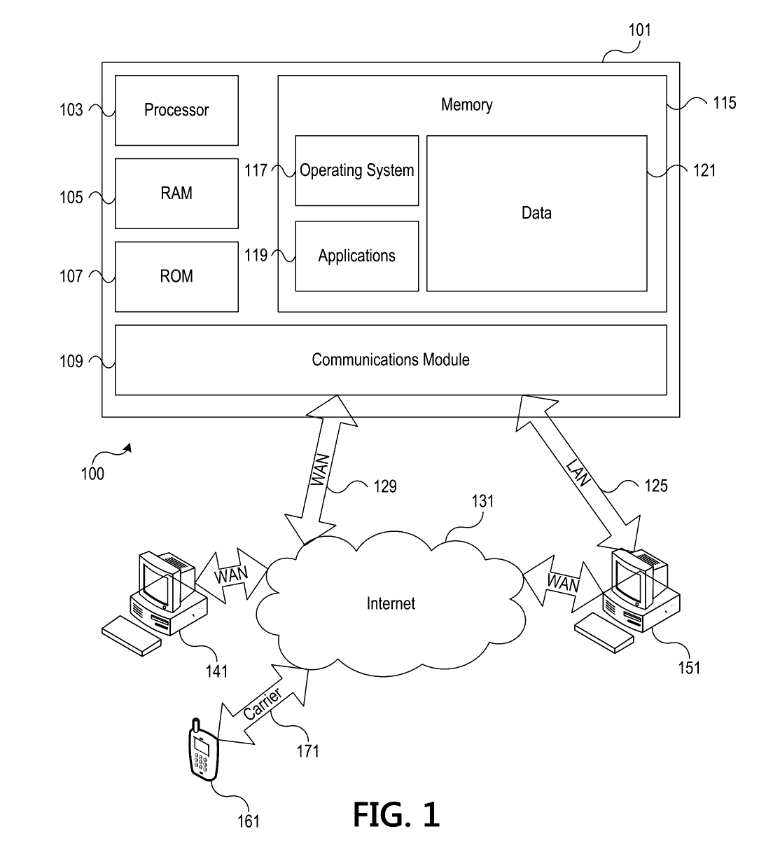

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files, scanning and identifying funds, such as cash, scanning and processing negotiable instruments, such as checks, converting negotiable instruments to digital files for processing, and the like.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like. In some examples, these known computing systems may be configured (e.g., with particular hardware, software, or combinations thereof) to perform the functions described herein. For instance, computing devices may be configured with particular hardware and/or software to perform the functions described herein (e.g., determining an amount of funds for deposit, providing instructions to package the funds in a container, authenticating a courier, determining an amount of funds received, determining whether the amount of funds for deposit matches the amount of funds received, tracking the container, and the like). In other examples, the computing device may be a special purpose computing device having particular components that are configured to perform the functions described herein.

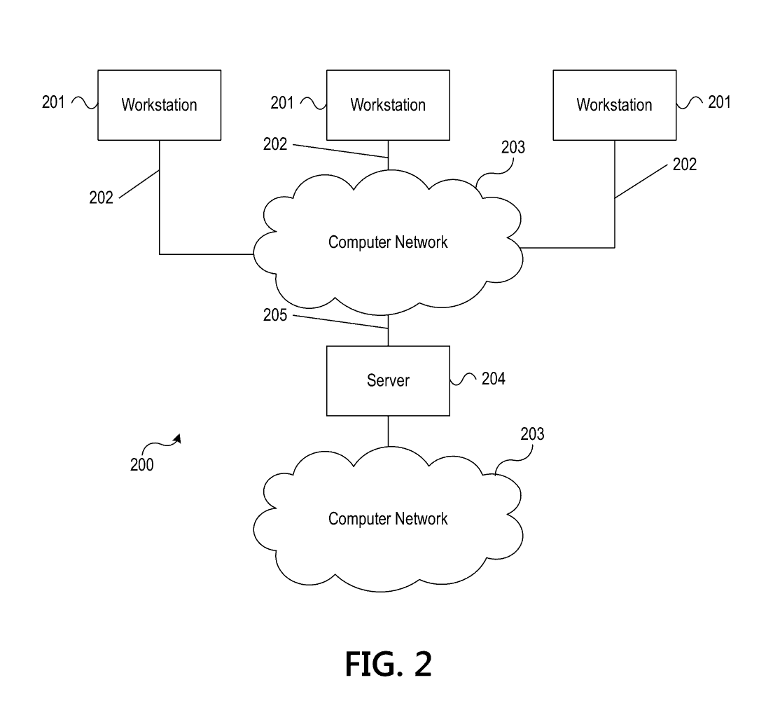

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like, that is configured to perform the particular functions described herein. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like. Various other types of communication may be used with aspects of this disclosure. For instance, communications such as radio frequency identification (RFID), near-field communication, Bluetooth, and the like, may be used with various aspects of the disclosure.

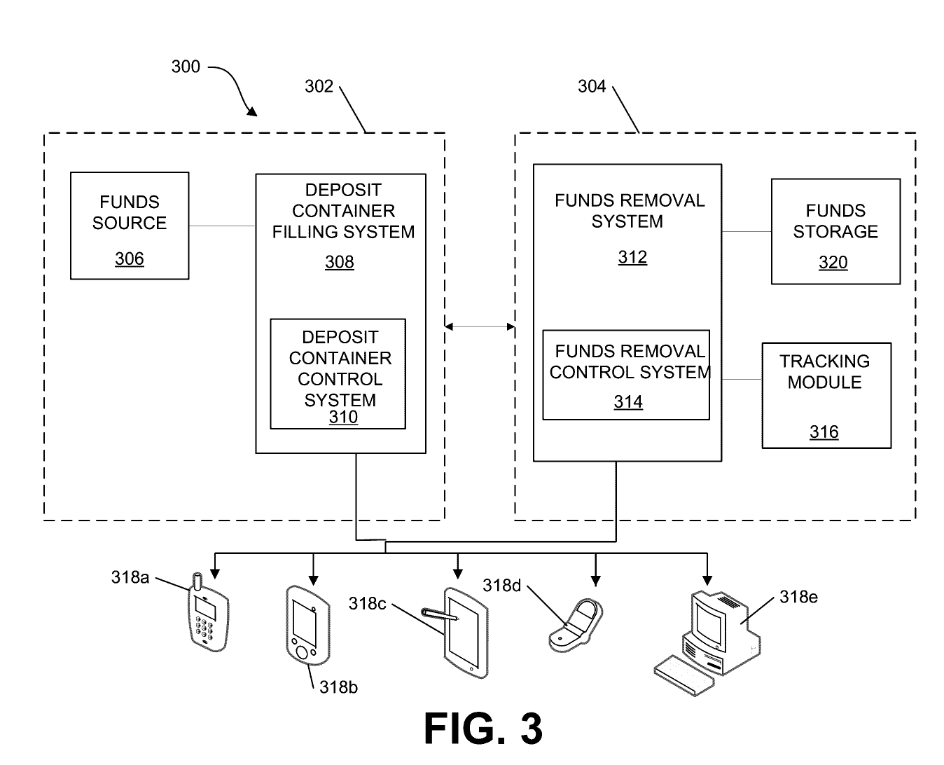

FIG. 3 illustrates one example traceable deposit container transfer system 300. In some examples, the traceable container transfer system 300 may include two or more entities between which a traceable deposit container may be transferred. For instance, as shown in FIG. 3, a first entity 302, such as a retail location, restaurant, or the like, may collect funds throughout the course of a business day, week, or the like. These funds are then transferred to a second entity 304, such as a financial institution, for deposit. In some arrangements, the transfer of funds may be performed on a periodic basis, such as at the close of each business day, once per week, or the like.

In some conventional systems, an employee of the first entity may determine (e.g., count) an amount of funds collected and being transferred for deposit and may hand-carry the funds for deposit from the first entity to the second entity. The second entity may then count the funds deposited and process the deposit. However, this system is often inefficient and prone to errors (e.g., the employee may have an inaccurate count of funds, a dishonest employee may remove funds for deposit, a discrepancy may exist between the amount for deposit and the amount received by the second entity which may delay processing, and the like).

Accordingly, the systems and methods described herein provide for an automated system of counting, packaging, transferring and confirming funds for deposit. For instance, the first entity 302 may include a funds source or funds containing device 306. In some examples, the funds source 306 may be a till from, for instance, a cash register. In another example, the funds source 306 may be a separate container or other device that may be inserted into, for instance, a deposit container filling system 308. The deposit container filling system 308 may be a device configured to receive the funds source 306 (e.g., via a slot or other opening in the deposit container filing system 308).

The deposit container filling system 308 may further include devices, apparatuses, systems, and the like, configured to remove funds (including cash, coins, checks or other negotiable instruments, and the like) from the funds source 306 and determine an amount of funds in the funds source 306. For instance, the deposit container filling system 308 may include a series of conveyors, rollers, mechanical arms, and the like, configured to remove funds from the funds source 308 and determine an amount of funds. In some examples, the deposit container filling system 308 may include a deposit container control system 310. The deposit container control system 310 may include some or all of the components described above with respect to computing device 101 in FIG. 1 and may part of the same physical device as the deposit container filling system or may be a separate physical device. Further, as funds are removed from the funds source 308 by the deposit container filling system 308, the deposit container control system 310 may count or otherwise determine an amount of funds received from the funds source 306. In some examples, determining the amount of funds may include scanning items, such as checks or other negotiable instruments, and using, for instance, optical character recognition (OCR), to determine an amount of the instrument. This amount may then be added to the amount of other funds (e.g., cash, coins, and the like) to determine an overall amount of funds.

In some examples, the funds source 306 may include funds that cannot be counted by the system. For instance, damaged bills or checks, other types of instruments that are not recognized (e.g., foreign currency, or the like). These funds may be removed from the funds source 306 and placed into a deposit container and the deposit container control system 310 may flag those funds and transmit a notification to, for instance, the second entity, that a particular container includes funds that were not recognized and therefore were not counted in the amount removed from the funds source 306.

Once an amount from the funds source 306 has been determined (e.g., by the deposit container control system 310) the amount may be transmitted to the second entity 304. For instance, the deposit container control system 310 may transmit the amount to a funds removal control system 314 at the second entity 304. This amount may be considered an expected amount of funds (e.g., an amount of funds expected to arrive at the second entity in the deposit container received from the first entity). This information may then be used to determine whether the amount of funds received by the second entity 304 matches the amount of funds removed from the funds source 306.

The funds removed from the funds source 306 may be placed in a deposit container (before or after transmission of the amount). In some examples, this step may be performed by the deposit container filling system 308 and deposit container control system 310. For instance, the deposit containing filling system may include one or more deposit containers. In some examples, the deposit containers may be reusable. The deposit containers may also be traceable. That is, the deposit container may include a tracking device that includes a unique identifier associated with one or more of the first entity, the second entity, a particular location of the first entity (e.g., in instances in which a retailer has multiple locations, the identifiers may include an identifier of the retailer entity as well as the particular location of that retailer from which the funds were collected).

In some arrangement, the tracking device may include a radio frequency identifier (RFID) tag or other non-contact identification or communication device. The RFID tag may be scanned by the deposit container filling system 308 upon filling the container with funds from the funds source 306. Accordingly, this initial scan may associate the RFID tag of the particular container with the first entity and the second entity. Accordingly as the container is transferred to a courier or the second entity, the RFID tag may be scanned and information transmitted to a tracking module 316. The tracking module 316 may include one or more aspects associated with the computing device 101 in FIG. 1 and may be configured to receive and/or store tracking information associated with a particular container. Accordingly, a chain of custody may be maintained for each container including times, dates, amounts, and the like. For instance, the chain of custody may include information associated with an entity in possession of the deposit container, a time and date of a transfer of possession, a location of the deposit container, and the like.

In another example, each container may have a scannable code, such as a bar code or quick response (QR) code, that may be unique to one or more of the container, the first entity, the second entity, and the like. In these examples, the scannable code may be scanned upon filling the container in order to begin the transfer process and tracking process. The container associated with the code may be transferred to the tracking module 316 along with time and date of tracking. Once the container is filled, an authorized courier may remove the container from the first entity and transfer the container to the second entity. The authorized courier may scan the scannable code on pickup of the container and this information may be transmitted to the tracking module 316. Upon dropping the container off at the second entity, a financial institution funds removal system 312 may scan the scannable code to confirm that the container was received. This information (e.g, establishing a chain of custody) may also be transmitted to the tracking module 316.

Various other examples of tracking a container may be used without departing from the invention. For instance, a drop in RFID card or tag may be included in each container. The drop-in card may be reusable and may be associated with the container, first entity, and/or second entity. The drop in RFID card or tag may be used to track the container in a manner similar to those discussed above with tracking information being transmitted to the tracking module 316.

As discussed above, the container used may be reusable. In some examples, the container may be a soft sided container, such as a bag. In other examples, the container may be a hard sided container such as a box. The container may be lockable (e.g., able to be secured and only opened or accessed by an authorized system or agent). The container may be large enough to hold various amounts of funds, such that an entity may have a container at the ready to accommodate unusually large amounts of funds for that particular entity and/or smaller amounts. Additionally or alternatively, the containers may be available in various sizes to permit entities to choose a container that will meet their needs (e.g., some entities may have few cash transactions and, as such, a small container may be sufficient, while other entities may be more cash based and, thus, would desire a larger container). In some examples, the container may be available in one or more standardized sizes to permit the container to be used with various different types of filling and funds removal systems.

In some arrangements, the container may be a hard-sided container and may be between 5″ and 8″ wide, between 7″ and 12″ long and between 1″ and 4″ thick. The deposit container may, in some examples, be sized to be carried by hand (e.g., by the hand of a courier or other agent) and, in some instances may include a handle for ease of carrying. The deposit container may be inserted into the deposit container filling system via a slot in the system and/or via a drawer and may be secured within the system. The deposit container, when inserted, may then be removable upon confirmation of identification of the courier or agent transporting the container.

As discussed herein, the funds removed from the funds source 306 may be placed into the deposit container for transfer to the second entity. In some examples, the container, when loaded to include the funds and closed and/or locked, may include a tamper resistant seal. For instance, the deposit container filling system 308 may load the container with the funds removed from the funds source 306 (e.g., via the conveyors, rollers, or other mechanical systems contained therein), may close and/or lock the container, and may place a tamper resistant seal on the container. The tamper resistant seal may include a strip (e.g., arranged across an opening in the container) that, if broken, would indicate that someone had accessed or attempted to access the funds within the container. In some examples, the tamper resistant seal may include a temperature sensitive seal that may indicate (e.g., via color change, watermark, or the like) whether excessive heating or cooling were applied to the seal in an attempt to remove the seal without breaking it (e.g., steam the seal off the container). In some arrangements, the seal may be placed on the deposit container prior to the amount of funds being transmitted from the first entity to the second entity. In other arrangements, the seal may be placed on the deposit container after the amount of funds has been transmitted from the first entity to the second entity.

In some examples, the hard-sided container may include a processor and communication interface that enabled communication between the systems and the deposit container. Accordingly, in some examples, the hard-sided container may have one side configured to open (e.g., to permit access to the interior of the container) and the side configured to open would open upon communication received from the filling system or the funds removal system (e.g., upon authentication). In some arrangements, this may be performed using a key pair. For instance, the container may have a public key of the key pair and the system (e.g., filling system, funds removal system) may have a private key of the key pair. The system may then transmit an “unlock” command to the container (e.g., an encrypted signal) and the container, upon receiving the encrypted “unlock” command may decrypt the command with the public key to provide a secure handshake upon authentication of the courier or agent. Use of a key pair is merely one example method of verifying an agent, an intended second entity recipient, or the like. Various other methods of verifying the agent, the desired recipient, and the like, may be used without departing from the invention.

Once the funds are in the container and the container is sealed, a courier or other authorized agent may remove the container from the first entity and transfer the container to the second entity 304. The container may be placed in a funds removal system 312 of the second entity 304. The funds removal system 312 may be configured to remove the funds from the container and determine an amount of funds within the container received by the second entity 304. Similar to the arrangements described above for the deposit container filling system 308, the funds removal system 312 may include a series of conveyors, roller, or other mechanical devices configured to remove the funds from the container and, in conjunction with the funds removal control system 314, count the funds received to determine an amount of funds received via the container. The funds removal control system 314 may include one or more computing devices having one or more components similar to computing device 101 in FIG. 1, and may be in the same physical device as the funds removal system or may be a separate physical device. The funds removal control system 314 may then determine whether the amount of funds received by the second entity 304 (e.g., the expected amount of funds transmitted from the first entity) matches the amount of funds removed from the funds source 306 at the first entity. If so, the deposit may be processed (e.g., automatically and/or funds may be available for withdrawal immediately upon deposit). If not, a notification may be transmitted to the first entity 302 indicating the discrepancy and a hold may be placed on the funds by the second entity 304 (e.g., the funds may not be immediately available for removal but instead may be held for further processing or confirmation of amount before being made available) or the funds may be provided a provisional credit may be provided for the deposit (e.g., a portion of funds may be available while a portion may be held).

Funds removed from the container by the financial institution funds removal system 312 may be transferred to one or more funds storage locations 320. The funds storage 320 may be a permanent storage device to hold the funds until removed as desired, or may be a temporary hold point for the funds until removed and transferred to a permanent holding location.

The deposit container control system 310 and/or the funds removal control system 314 may be accessed by a user via one or more of computing devices 318a-318e. For instance, a user may access one or more of control systems 310 or 314 via a smartphone 318a, personal digital assistant (PDA) 318b, tablet computing device 318c, cell phone 318d, and/or other computing device 318e. A user may modify settings of one or more of the control systems, may access tracking information from tracking module 316, or monitor a transfer process via one or more of the computing devices 318a-318e.

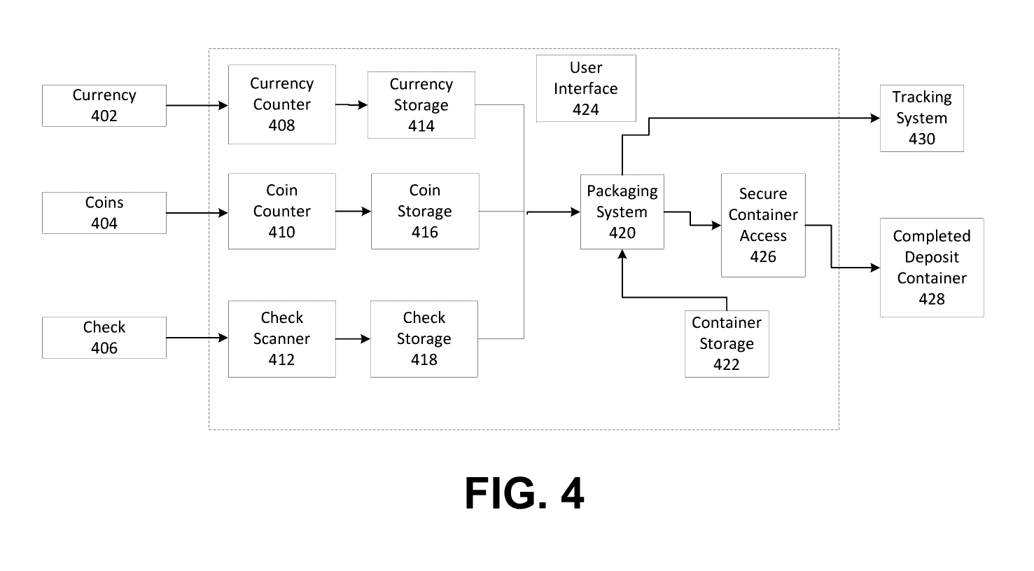

FIG. 4 illustrates another example including additional features of the deposit containing filling system described with respect to FIG. 3 providing additional aspects of the filling system and associated components (e.g., 306, 308, 310). For instance, currency (e.g., paper currency) 402, coins 404 and checks and/or other instruments 406 may be received by the filling system. Each type of funds may, in some examples, be counted by a respective counter. For instance, currency 402 may be counted by currency counter 408, coins 404 may be counted by coin counter 410, and checks or other instruments may be counted by a scanner 412 which may scan the instrument and, using OCR, may determine an amount of the instrument. Accordingly, each counter 408, 410, 412 may have appropriate mechanical devices to remove the funds, transfer the funds, and the like. Counting aspects may be performed by one or more components associated with a control system, such as system 310 in FIG. 3, as associated with, for instance, user interface 424.

In the example of FIG. 4, each type of funds may then be held in a respective storage location. For instance, currency 402 may be held in currency storage 414, coins 404 may be held in coin storage 416, and checks or other instruments may be held in check storage 416. In other examples, the different types of funds may be stored together in a combined storage area.

The system further includes a packaging system 420, which, as discussed above, may include various mechanical systems, such as conveyors, rollers, and the like, to move funds through the process. The packing system 420 may receive a container from container storage 422 in which a plurality of containers may be stored. In some examples, the containers may be stored within the filling system. In other examples, one or more containers may be inserted into the system at a designated time in order to enable a filling operation. In some examples, funds may be counted by the system and, upon receiving the deposit container in the system, a loading operation may commence.

The funds may be placed in the container received and may be sealed. Access to the container (e.g., to an authorized courier or agent) may be provided via secure container access 426, as will be discussed more fully herein. The completed deposit container 428 may then be removed from the filling system and transferred to the second entity. The tracking system 430 may be used to monitor status of the container, location of the container, possession of the container, and the like, as is discussed more fully herein.

These and other arrangements will be discussed more fully below.

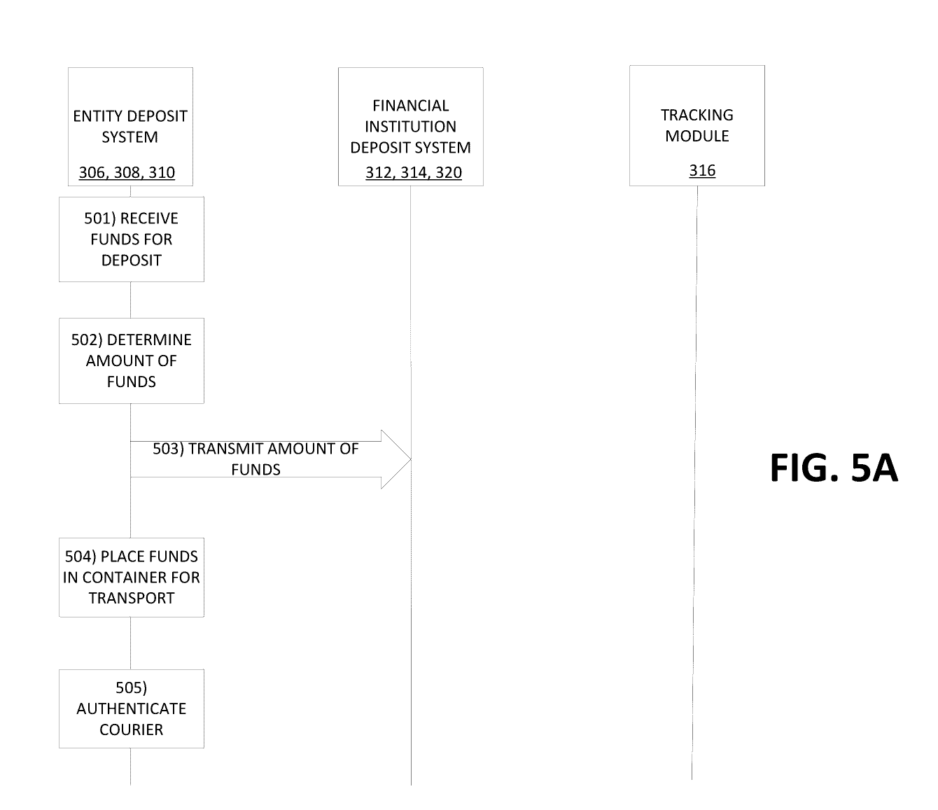

FIGS. 5A and 5B illustrate one example event sequence for packaging and transferring funds from a first entity to a second entity, according to one or more examples discussed herein. The example shown in FIGS. 5A and 5B is merely one example sequence and various other steps, processes, or the like, may be included in this or other example sequences without departing from the invention.

With reference to FIG. 5A, in step 501, funds may be received by the deposit container filling system 308. As discussed herein, the funds may include currency, such as paper currency, coins, checks or other negotiable instruments, and the like. The funds may be located at a first entity, such as a retail location of a store, a restaurant, or the like. The funds may be received by the system and may be counted to determine an amount of funds in step 502. The amount of funds may be transmitted to a second entity, such as a financial institution, in step 503. In some examples, transmitting the amount of funds may initiate a deposit transaction at the second entity. For instance, the second entity may receive the amount of funds and may pre-process a deposit to more efficiently process the transaction. Pre-processing the deposit may include identifying an account to which the funds will be deposited. Pre-processing may also include performing virtually all steps of a deposit transaction but only completing the deposit upon receiving the funds at the financial institution (e.g., second entity) and confirming that a received amount of funds matches the amount of funds transmitted in step 503.

In step 504, the funds at the entity may be placed in a container for transfer to the second entity. As discussed herein, the container may be reusable and traceable, to enable the system to follow the possession and progress of the container throughout the transfer and store a record of this information.

A courier or authorized agent may request to remove the container from the entity. In order to permit removal of the container, the system may authorize the courier in step 505. In some examples, the courier may be an armored car service. In other examples, the courier may be an employee of the first entity, a general courier, or a ride sharing service driver (e.g., who may be requested to transfer the container).

If the courier is authorized, the container may be transferred from the first entity to the second entity in step 506. In step 507, tracking information associated with transfer of the container may be transmitted to tracking module 316.

In step 508, the second entity may count the received funds from the container to determine an amount of funds received. In step 509, the system may confirm that the amount of funds received in step 508 matches the amount of funds transmitted in step 503. If not, a notification may be transmitted to the first entity. If so, the deposit may be processed and the funds stored in step 510.

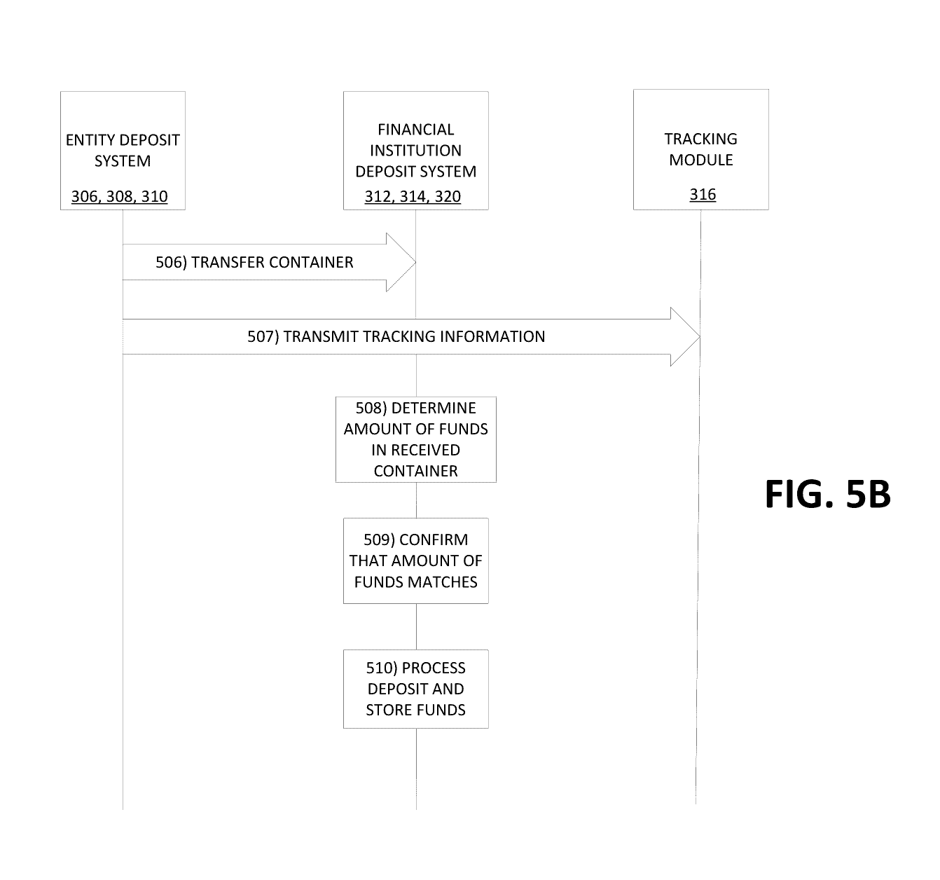

FIG. 6 illustrates one example method of loading funds in a container and transferring the container from a first entity to a second entity, according to one or more aspects described herein. In step 600, funds may be received. In some examples, the funds may include currency, coins, and/or checks or other negotiable instruments. In step 602, an amount of funds received for packaging and deposit may be determined. As disused herein, the different types of funds may be counted separately or together, and an overall amount of funds may be determined. This amount may be the amount of funds to be deposited at a second entity, such as a financial institution.

In step 604, the amount of funds to be deposited may be transmitted to the second entity (e.g., a computing device of the second entity). In some examples, this may begin a deposit process and the system may automatically pre-process the deposit transaction.

In step 606, the funds may be placed in a deposit container for transfer from the first entity to the second entity. In some examples, the container may be reusable and/or traceable, as discussed herein. Further, although in FIG. 6 the amount of funds shown as being transmitted to the second entity prior to the funds being placed in the deposit container, some example arrangements may include placing the funds in the container prior to transmitting the amount of funds to the second entity. The deposit container may be sealed using a tamper resistant seal and may be transferred to the second entity in step 608.

In step 610, the funds may be removed from the deposit container and/or counted to determine an amount of funds received by the second entity. In step 612, a determination is made as to whether the amount determined in step 610 matches the amount received by the second entity in step 604. If so, the deposit may be processed (e.g., the deposit transaction begun by the system may be completed) and a notification may be transmitted to the first entity of completion of the deposit.

If, in step 612, the amounts do not match, a hold may be placed on the funds or a provisional credit may be provided to the first entity (e.g., a portion of the funds made available immediately and a portion held for a predetermined amount of time and then released) and a notification of the discrepancy between the amount of funds may be transmitted to the first entity. Additional investigation may then be conducted to determine the source of the discrepancy and/or take any corrective measures.

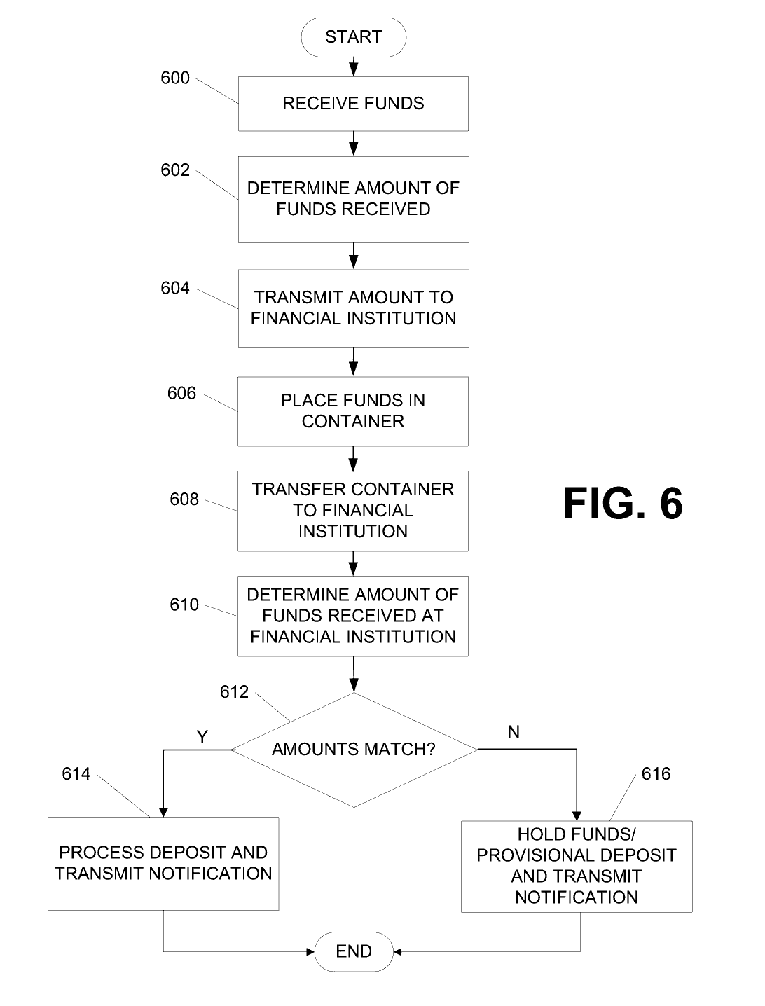

FIG. 7 illustrates one example method of authenticating a request to transfer the container according to one or more aspects described herein. In step 700, a request to remove the container from the first entity may be received. In some examples, the request may be received via a computing device located proximal to the first entity or deposit container filling system (e.g., one or more of computing devices 318a-318e). In another example, the request may be made from a remotely located computing device (e.g., a mobile device of a courier or authorized agent).

In step 702, a request to provide authenticating information may be transmitted to the computing device from which the request to transfer the deposit container was received. The request may include a request for a username and password, biometric data such as a fingerprint, retinal scan, or the like, or various other types of authenticating information. In some examples, a proximity sensor may be used to determine whether the courier (e.g., a mobile device of the requesting courier or agent) is within a predefined distance of the deposit container (e.g., a distance between a tracking device of the deposit container and the mobile device is within a predefined threshold). This may be used as a secondary authentication process to ensure that the courier is present to pick up the container.

In step 704, authenticating information may be received from the courier or agent. In step 706, a determination is made as to whether the received authenticating information matches pre-stored authenticating information. For instance, the first entity may have a database storing authorized couriers or agents. Authenticating information for each authorized courier or agent may be stored in the database. For instance, each authorized courier or agent may register with the system, the first entity, the second entity, or combinations thereof. Registration may include providing authenticating information for storage. Accordingly, a matching process may be performed to determine whether the received authenticating information matches the stored authenticating information.

If the authenticating information matches in step 706, the requesting party may be permitted to remove the container in step 708 and, in step 710, tracking information associated with removal of the container may be transmitted to a tracking module. If, in step 706, the authenticating information does not match, the requesting party may be prevented from removing the container and a notification of potential unauthorized access may be transmitted to the first entity and/or the second entity.

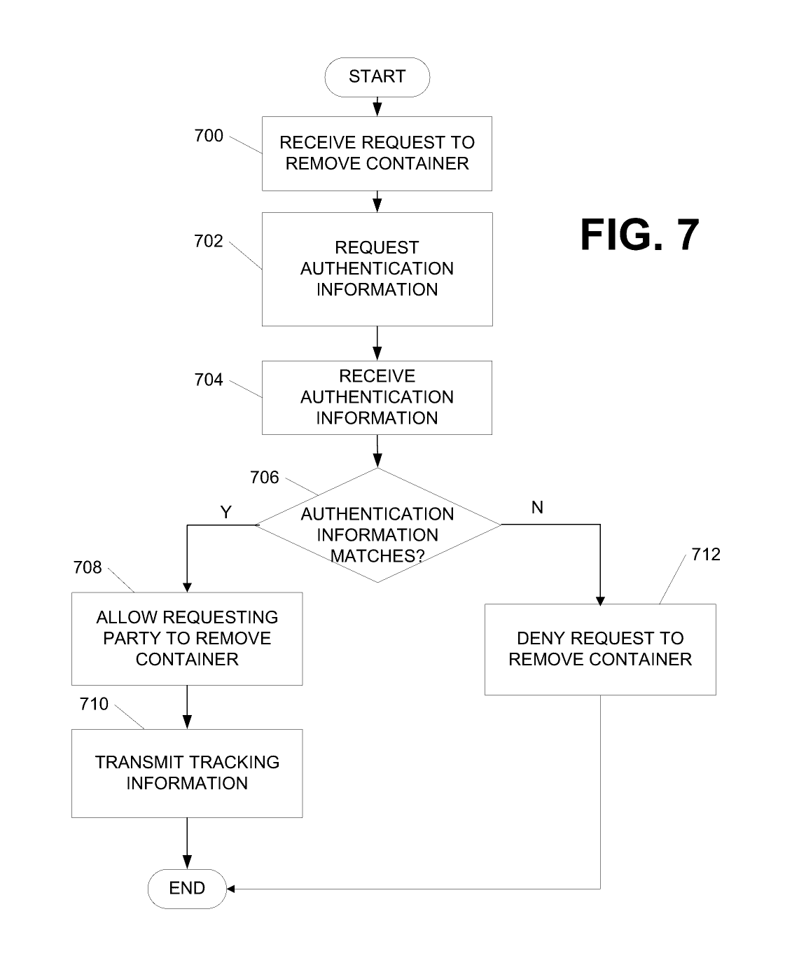

FIG. 8 illustrates one example user interface through which a courier or agent may provide authenticating information. The interface 800 includes region 802 in which a courier or agent's name may appear. In some examples, the courier or agent may enter his or her name in field 802. In other examples, this field may be automatically populated based on a scheduled pickup of a deposit container.

In field 804, the courier or agent may enter his or her username and in field 806 a password may be entered. Additionally or alternatively, the user may place his or her finger, thumb, or the like, in field 808 for fingerprint scanning. One or both of these authentication devices may be used to determine whether the courier is authorized to remove the deposit container.

Once the information has been entered, the user may select “OK” option 810 to process the information provided. Alternatively, the user may select “CLEAR” option 812 to remove all entries made.

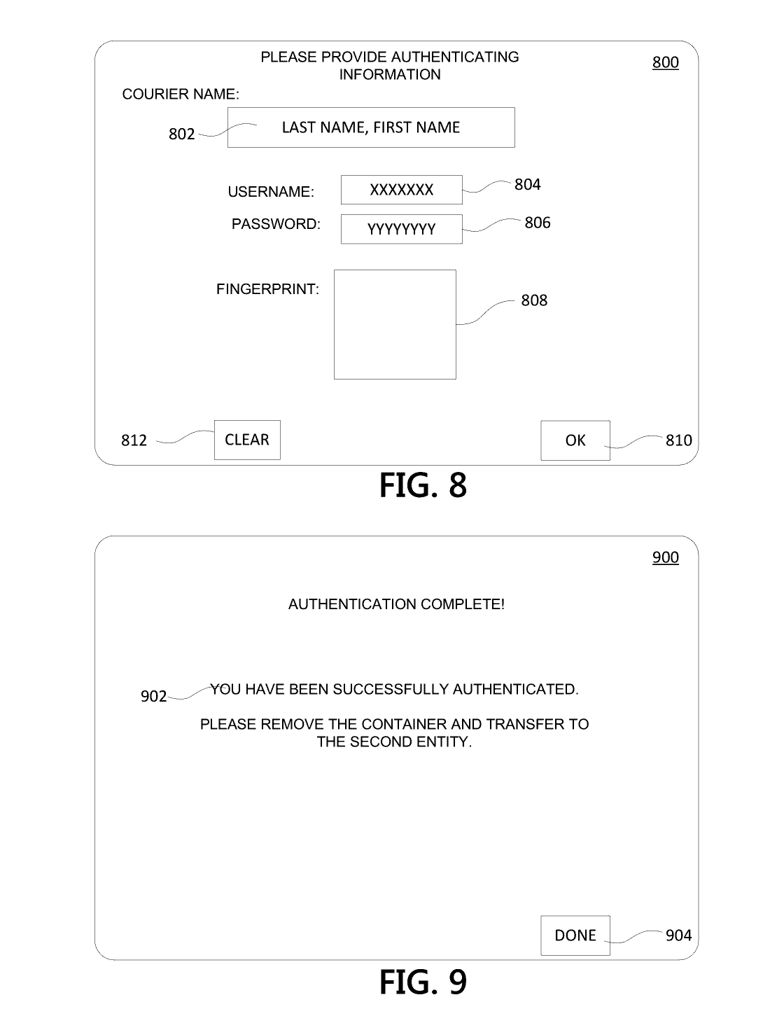

FIG. 9 illustrates one example user interface 900 indicating that the courier or agent has been successfully authenticated to the system. For instance, region 902 provides an indication to the courier that he or she has been successfully authenticated and that he or she may remove the container and transfer the container to the second entity. When finished reviewing the instructions, the user may select “DONE” option 904.

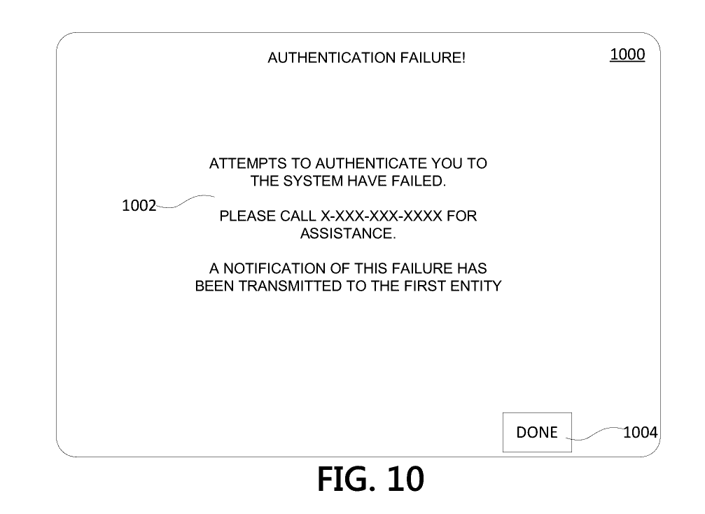

FIG. 10 illustrates one example user interface for providing an indication that an authenticating process has failed. For instance, field 1002 in interface 1000 indicates that attempts to authenticate the courier have failed and provides contact information for assistance. When finished reviewing the interface, the user may select “DONE” option 1004.

As discussed herein, one or more aspects of the systems and arrangements described may be performed automatically by an automated system (e.g., without additional user interaction). For instance, once the funds source is provided to the deposit container filling system, the filling system may automatically count the funds from the funds source, load the funds into the deposit container, seal the container, and transmit the amount of funds to the second entity. In another example, once the deposit container is delivered to the funds removal system at the second entity, the funds removal system may automatically remove the funds from the deposit container, determine an amount of funds in the container, determine whether the amount of funds matches the amount (e.g., expected amount) transmitted from the first entity, and either complete the deposit or take other action based on the determination.

Although various aspects described herein are directed to a system in which funds are collected at the first entity (e.g., a retail establishment) and transferred to a second entity (e.g., a financial institution), in some examples, the process may be performed in reverse, to permit transfer of the deposit container from the second entity to the first entity. For instance, if a first entity has requested a number of a certain denomination of currency (e.g., twenty dollar bills, one dollar bills, or the like), the second entity may load the requested currency into a deposit container, the container may be transferred from the second entity to the first entity (e.g., by a courier or agent) and the funds may be removed at the first entity.

As discussed herein, the systems and processes described provide an efficient process for transferring funds for deposit that may reduce or eliminate errors, possibility of unauthorized activity, and the like. By providing an automated or substantially automated process, the possibility for human error is reduced or eliminated. For instance, the automated counting of funds on both the filling end and the removal end may aid in reducing or eliminating errors. Further, by transmitting an expected amount of funds, any discrepancies that may exist may be quickly identified, investigated and remedied.

In addition, such an automated or substantially automated system may reduce or eliminate the need for user interaction (e.g., by stationing trusted personnel) at the first entity or the second entity. For instance, many businesses, such as retail stores, restaurants, and the like, close well after a financial institution closes. Accordingly, the systems and arrangements described herein may permit drop off of the deposit container and, in some examples, completion of a deposit of funds, after a closing time of the financial institution because the automated system may count the funds, place them in a secure container, confirm an expected amount, complete the deposit transaction, and the like by virtually anyone rather than requiring employees of the first entity or second entity to be present, make the transfer, or the like. As such, an efficient “after hours” arrangement for transferring and depositing funds is provided.

Although in many arrangements discussed above the second entity is described as being a financial institution, in some examples, the second entity (e.g., location to which funds are transferred and at which funds are deposited) may be a system with a processor acting on behalf of the actual custodian of the funds (e.g., the financial institution at which the deposit is being made). For example, the deposit container may be transferred to a cash vault operation operated by a third party or entity (e.g., a party or entity other than the retail location first entity or financial institution second entity). The deposit information may be transmitted to the second entity financial institution but the funds themselves may be received by the third party system. Various funds may be received by the third party system (e.g., from a plurality of first entities) and then transferred to the financial institution as desired.

The systems and arrangements described herein also improve productivity by allowing for automated counting of the funds both at the deposit filling system and at the funds removal system. This reduces or eliminates the need for human interaction which can be prone to error and permits personnel resources to be allocated to other duties.

Further, as discussed herein, the systems and arrangements described herein allow for a secure, lockable, strong and sturdy container to be used, and reused, to transport funds. The container may allow for thorough tracking of the container, funds being deposited, and the like. In some arrangements, tracking capabilities may allow a user (e.g., at the first entity or the second entity) to track the deposit container (using, for instance, a unique container identifier) at any point along the transfer. For instance, similar to a package delivery service that permits tracking of packages from the shipping point to the delivery point, including timing and the like, the deposit container may also be tracked and that information may be made available to authorized users of the system. This further enhances the ability to control, monitor and understand the chain of custody of the funds from start to finish without relying on user interaction.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the modules, systems, devices, control systems, and the like, discussed above may be combined into a device, and the various functions of each module may be performed by the single computing device. In such arrangements, any and/or all of the above-discussed communications between modules, systems, devices, control systems, and the like, may correspond to data being accessed, moved, modified, updated, and/or otherwise used by the single computing device. Additionally or alternatively, one or more of the modules, systems, devices, control systems, and the like, discussed above may be implemented in one or more virtual machines that are provided by one or more physical computing devices. In such arrangements, the various functions of each module, system, device or control system may be performed by the one or more virtual machines, and any and/or all of the above-discussed communications between modules may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
a deposit container;
a processor;
a memory operatively coupled the processor and storing computer-executable instructions that, when executed by the processor, cause at least one computing device to:
determine an amount of funds in the deposit container at a first entity;
transmit the recorded amount of funds to a second entity;
receive, from a courier, a request to remove the deposit container from the first entity and transfer it to the second entity;
request, from the courier, authentication information of the courier;
receive, from the courier, authentication information of the courier;
determine whether the received authentication information matches pre-stored authentication information of the courier;
responsive to determining that the authentication information does not match the pre-stored authentication information of the courier, preventing the courier from removing the deposit container from the first entity;
responsive to determining that the authentication information matches, authorizing the courier to remove the deposit container from the first entity and transfer it to the second entity; and
responsive to authorizing the courier to remove the deposit container from the first entity, receive a notification that the deposit container was received by the second entity.

2. The system of claim 1, further including:
sealing the deposit container with a tamper resistant seal.

3. The system of claim 1, wherein the deposit container is traceable using a tracking device.

4. The system of claim 3, wherein the tracking device includes at least one of: a scannable code and a radio frequency identifier (RFID) tag.

5. The system of claim 1, wherein the deposit container is reusable.

6. The system of claim 1, wherein the second entity is a financial institution and the amount of funds in the deposit container is an amount of funds collected by the first entity and being deposited at the financial institution.

7. The system of claim 1, wherein steps performed by the computing device are performed automatically.

8. The system of claim 1, wherein the received authentication information of the courier includes at least one of: a username and password combination and biometric data.

9. A system, comprising:
a deposit container;
a processor;
a memory operatively coupled the processor and storing computer-executable instructions that, when executed by the processor, cause at least one computing device to:
receive, from a first entity, an expected amount of funds to be received by a second entity;
responsive to receiving the expected amount of funds, initiating, by the second entity, a deposit transaction;
receive, by a funds removal device of the second entity, the deposit container from the first entity, the deposit container including an amount of funds;
receive tracking information associated with the deposit container, the tracking information including at least identifying information of the first entity and the second entity and a chain of custody of the deposit container;
remove, from the deposit container, and determine the amount of funds;
determine whether the amount of funds matches the expected amount of funds received from the first entity;
responsive to determining that the expected amount of funds matches the amount of funds, completing the initiated deposit transaction including depositing the amount of funds in an account of the first entity; and
responsive to determining that the expected amount of funds does not match the amount of funds, further processing the deposit transaction to place a hold on the amount of funds received by the second entity.

10. The system of claim 9, wherein the expected amount of funds is an amount of funds expected to be received by the second entity at a future time.

11. The system of claim 9, wherein the tracking information includes information generated by tracking at least one of: a scannable code and a RFID tag attached to the deposit container.

12. The system of claim 9, wherein the second entity is a financial institution.

13. The system of claim 9, wherein the deposit container is reusable.

14. The system of claim 9, wherein the expected amount of funds is an amount of funds placed into the deposit container by the first entity when the deposit container was located at the first entity.

15. A method, comprising:
determining, by a deposit container filling system of a first entity, an amount of funds in a deposit container at the first entity;
transmitting, by the deposit container filling system, the determined amount of funds in the deposit container to a second entity;
receiving, from a computing device of a courier and by the deposit container filling system, a request to remove the deposit container from the first entity and transfer it to the second entity;
transmitting, from the deposit container filling system to the computing device of the courier, a request for authentication information of the courier;
receiving, from the computing device of the courier, authentication information of the courier;
determining, by the deposit container filling system, whether the received authentication information matches pre-stored authentication information of the courier;
responsive to determining that the authentication information does not match the pre-stored authentication information of the courier, preventing, by the deposit container filling system, the courier from removing the deposit container from the first entity;
responsive to determining that the authentication information matches, authorizing, by the deposit container filling system, the courier to remove the deposit container from the first entity and transfer it to the second entity; and
responsive to authorizing the courier to remove the deposit container from the first entity, receiving a notification that the deposit container was received by the second entity.

16. The method of claim 15, wherein the deposit container is traceable.

17. The method of claim 16, further including tracing the deposit container by tracking at least one of: a scannable code and an RFID tag on the deposit container.

18. The method of claim 15, further including:
receiving, by a funds removal system of the second entity, an expected amount of funds to be received by the second entity;
responsive to receiving the expected amount of funds, initiating, by the second entity, a deposit transaction;
receiving, by the funds removal system of the second entity, the deposit container from the first entity, the deposit container including an amount of funds;
determining, by the funds removal system of the second entity, the amount of funds in the deposit container received from the first entity;
determining, by the funds removal system, whether the amount of funds matches the expected amount of funds received from the first entity;
responsive to determining that the expected amount of funds matches the amount of funds, completing a deposit transaction of the amount of funds including depositing the amount of funds in an account of the first entity; and
responsive to determining that the expected amount of funds does not match the amount of funds, further processing the deposit transaction of the amount of funds to place a hold on the amount of funds received by the second entity.

19. The method of claim 15, further including;
sealing, by the deposit container filling system, the deposit container with a tamper resistant seal.

20. The method of claim 15, wherein the method is performed automatically.
